(19) United States
(12) Patent Application Publication
(10) Pub. No.: US 2006/0029758 A1
(43) Pub. Date: Feb. 9, 2006

(54) Refrigerator with an inner case containing nanosilver particles

(75) Inventor: Jin Soo Kim, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/248,235

(22) Filed: Oct. 13, 2005

Related U.S. Application Data
(63) Continuation-in-part of application No. 10/618,241, filed on Jul. 10, 2003, now abandoned.

(30) Foreign Application Priority Data
Jan. 14, 2003 (KR) 10-2003-0002294

(51) Int. Cl. B32B 5/16; B32B 27/32; A47B 77/08; B32B 15/02

(52) U.S. Cl. 428/35.9; 428/328; 428/521; 312/236

(57) ABSTRACT

A refrigerator includes an outer case, an inner case containing nanosilver particles and a heat insulating material disposed between the outer case and the inner case. The inner case includes a first layer made of a first resin for defining an inner space of the refrigerator and accommodating foods therein and a second layer made of a second resin. The second layer is devoid of the nanosilver particles and disposed between the first layer and the beat insulating material. The nanosilver particles in the first layer have a size of about 200˜300 nm and a concentration of about 30˜200 ppm based on the weight of the first layer.

### CROSS REFERENCE TO RELATED APPLICATION

This application is a continuation-in-part application of U.S. Ser. No. 10/618,241 filed on Jul. 10, 2003, which claims priorities thereon pursuant to 35 USC 120.

### FIELD OF THE INVENTION

The present invention relates to a refrigerator with an inner case for defining an inner space of the refrigerator; and, more particularly, to a refrigerator including an inner case divided into two parts one of which contains nanosilver particles exhibiting optimal antibacterial and/or antifungal functions.

### BACKGROUND OF THE INVENTION

In general, silver (Ag) is well-known as a common antibacterial agent. In particular, colloidal silver is known as being safe and effective against, bacteria, fungi, microbes, virus and the like. When silver ions are absorbed into cells of virus, bacteria, fungi and the like, the silver ions prevent the growth of enzyme required in respiration thereof to render them dead. Further, silver ions prevent metabolism of the bacteria and suppress reproduction thereof.

Fine particles of silver can be produced by a physical process such as electrolysis, liquid phase reduction, and grinding. The electrolysis has mainly been used hitherto in order to obtain stabilized nanosilver particles with a high purity. In the electrolysis process, pure silver (99.99%) is immersed into distilled water; and extremely fine particulates of silver are obtained by applying a low current at a low temperature.

Meanwhile, a refrigerator serves to preserve food in a fresh state for an extended period of time in a food storage compartment by cooling air in the compartment using a refrigeration cycle. In the refrigerator, refrigerant gas compressed under a high temperature and a high pressure by a compressor is condensed into liquid phase in a condenser; and the liquid is then pressure-reduced through an expansion valve and evaporated in an evaporator. At this time, the evaporating refrigerant takes heat from the ambient air to cool it. The cooled air is then forced into the food storage compartment by, e.g., a fan.

A study on employing the above-described nanosilver for an antibacterial purpose in the refrigerator has been conducted, in which the inner case of the refrigerator, which defines an inner space of the refrigerator, serves the antibacterial purpose by making it of nanosilver.

The inner case of the refrigerator is typically made of acrylonitrile butadiene styrene(“ABS”) copolymer since the styrene base resin such as the ABS copolymer has an excellent mechanical property, workability, appearance, gloss and the like. The inner case of the refrigerator is manufactured by the ABS copolymer to a sheet and then performing a vacuum forming process on it.

The vacuum forming process is one type of plastic forming process, the vacuum forming process including extruding a resin to a sheet, heating and softening the sheet in a vacuum forming machine to form a softened sheet, and drawing the softened sheet to a mold so as to form it into a shape required by using a vacuum of air or a vacuum and a compact of air to manufacture a desired product. This vacuum forming process is widely used to produce the inner case of the refrigerator.

Such an inner case is mixed with nanosilver particles by adding nanosilver particles to the ABS solvent contained in the master batch. This permits nanosilver to be wastefully used since nanosilver particles are added even in forming a portion of the inner case in which antifungal function is not required. Accordingly, such production is cost ineffective.

### SUMMARY OF THE INVENTION

It is, therefore, a primary object of the present invention to provide a refrigerator including an inner case capable of having reduced amount of nanosilver particles to be contained therein.

It is another object of the present invention to provide a refrigerator capable of controlling a color tone thereof while employing a reduced amount of nanosilver particles in an inner case of the refrigerator.

In accordance with an aspect of the present invention, there is provided a refrigerator capable of controlling a color tone thereof, which includes: an outer case; an inner case containing nanosilver particles; and a heat insulating material disposed between the outer case and the inner case, wherein the inner case includes a first layer made of a first resin for defining an inner space of the refrigerator and accommodating foods therein and a second layer made of a second resin, the second layer being devoid of the nanosilver particles and disposed between the first layer and the beat insulating material, the nanosilver particles having a size of about 200˜300 nm and a concentration of about 30˜200 ppm based on the weight of the first layer.

Preferably, the inner sheet and the outer sheet are bonded to each other by a double extrusion molding technique.

### BRIEF DESCRIPTION OF THE DRAWING

The above and other objects and features of the present invention will become apparent from the following description of preferred embodiments given in conjunction with the accompanying drawing in which:

FIG. 1 is a schematic cross sectional view of an inner case of a refrigerator in accordance with the present invention.

### DETAILED DESCRIPTION OF THE PREFERRED EMBODIMENTS

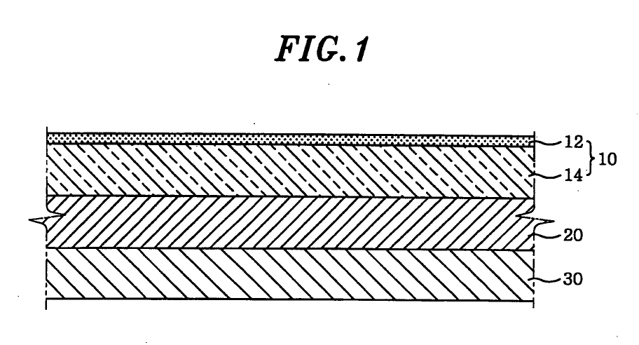

A preferred embodiment of the present invention will now be described in detail with reference to FIG. 1 showing a schematic cross sectional view of a case of a refrigerator in accordance with the present invention.

As shown in FIG. 1, the case includes an inner case 10, an outer case 30 for forming an appearance of the refrigerator and a heat insulating material 20 provided therebetween.

The inner case 10 has an inner sheet 12 for defining an inner space of the refrigerator and an outer sheet 14 formed on the heat insulating material 20. The inner sheet 12 may come into contact with food, the user or the air contaminants and thus the antifungal function is required, while the outer sheet 14 does not. Accordingly, nanosilver particles having antifungal function are contained in the only inner sheet 12 while the outer sheet 14 is made of a typical acrylonitrile butadiene styrene(“ABS”) copolymer. This reduces amount of the nanosilver particles to be used in the inner case 10. Accordingly, it is preferable that the thickness of the inner sheet 12 is minimized so as to further decrease amount of nanosilver to be contained therein. The inner sheet 12 and the outer sheet 14 are bonded to each other by, e.g., a double extrusion molding technique.

It was found by the inventor of the present invention that nanosilver particles exhibit darker brown color as the size thereof becomes small; and therefore in the preferred embodiment of the present invention, the size of the nanosilver particles is limited to 200˜300 nm in consideration of the efficiency of specific surface area per unit weight and the ability of controlling a color tone of the inner case of the refrigerator.

Further, the concentration of the nanosilver added to the inner sheet 12 is limited to a range of about 30˜200 ppm by weight base on the weight of the inner sheet 12 such that the expensive nanosilver can efficiently be used and a target antibacterial ability can be obtained. As the concentration of the nanosilver is increased, the antibacterial ability is enhanced. However, it was found that, if the concentration of the nanosilver particles reaches 200 ppm by weight, the antibacterial ability of the refrigerator is saturated. Further, if the concentration of the nanosilver particles is less than 30 ppm, the effect of employing the nanosilver particles can be barely observed. In addition, in the above concentration range of nanosilver, the sterilization or bacteriostasis can be performed stably and efficiently.

With such an inner case of the refrigerator, it is possible to reduce the product cost of the refrigerator since amount of nanosilver particles to be contained in the inner case thereof is reduced.

While the invention has been shown and described with respect to the preferred embodiments, it will be understood by those skilled in the art that various changes and modifications may be made without departing from the spirit and scope of the invention as defined in the following claims.

What is claimed is:

1. A refrigerator capable of controlling a color tone thereof, which comprises:
an outer case;
an inner case containing nanosilver particles; and
a heat insulating material disposed between the outer case and the inner case,
wherein the inner case includes a first layer made of a first resin for defining an inner space of the refrigerator and accommodating foods therein and a second layer made of a second resin, the second layer being devoid of the nanosilver particles and disposed between the first layer and the heat insulating material, the nanosilver particles having a size of about 200˜300 nm and a concentration of about 30˜200 ppm based on the weight of the first layer.

2. The refrigerator of claim 1, wherein the inner sheet and the outer sheet are bonded to each other by a double extrusion molding technique.

3. The refrigerator of claim 1, wherein the inner sheet and the outer sheet are made of same resin.

4. The refrigerator of claim 4, wherein the resin is acrylonitrile butadiene styrene copolymer.
